(19) United States
(12) Patent Application Publication
(10) Pub. No.: US 2025/0166588 A1
(43) Pub. Date: May 22, 2025

(54) METHOD FOR COMPENSATING A USER'S DEFECTIVE VISION FOR A DISPLAY APPARATUS, DISPLAY APPARATUS, COMPUTER PROGRAM, AND COMPUTER-READABLE MEDIUM

(71) Applicant: SCHWIND EYE-TECH-SOLUTIONS GMBH, Kleinostheim (DE)

(72) Inventors: Pascal NAUBEREIT, Laufach (DE); Masoud MEHRJOO, Aschaffenburg (DE)

(21) Appl. No.: 18/945,983

(22) Filed: Nov. 13, 2024

(30) Foreign Application Priority Data
Nov. 20, 2023 (DE) 10 2023 132 267.2

(51) Int. Cl. G09G 5/37; G06F 3/14; G06V 10/60

(52) U.S. Cl. CPC G09G 5/37; G06F 3/14; G06V 10/60; G09G 2320/04

(57) ABSTRACT

The invention relates to a method for compensating a visual defect of a user for a display apparatus (100), wherein the method comprises the following steps: determination of visual defect parameters of the user using an input device (30); calculation of compensation data by a compensation data calculation device (20) for adaptation of predefined image data based on the visual defect parameters; adaptation of the predefined image data as a function of the compensation data by the control device (40); and actuation of a display device (10) of the display apparatus (100) by the control device (40) with the adapted image data.

### FIELD

The invention relates to a method for compensating a user's defective vision for a display apparatus, a display apparatus, a computer program, and a computer-readable medium.

### BACKGROUND

It is known to use visual aids and/or to perform refractive surgery in order to make display devices of, for example, smartphones, laptops, head-up displays (HUDs), e-book readers, PC monitors, televisions, etc. usable for ametropic persons. An ametropic person is distinguished by the fact that, in a non-accommodated state of the eye(s), they can see only blurred. Reasons for this may be short vision or long vision, astigmatism, higher-order imaging errors, or even restrictions due to opacities, scarring, and so on.

It has been proposed to use complex multidimensional display devices in which an upstream optical system such as an adaptive optical system, a multi-lens array, or a further LCD plane can be set in front of one of the aforementioned display devices in such a way that imaging errors caused by the human visual apparatus can be partially compensated. This is illustrated, for example, in document ACM Transactions on Graphics, Vol. 31, No. 4, pp. 1-12 (2012), which can be accessed at https://doi.org/10.1145/2185520.2185577.

For many reasons, only in the case of a few ametropic persons is a surgical correction of defective vision performed using, for example, a Lasik, Lasek, PRK, or trans-PRK method. Reasons for this may be diverse, such as, for example, a contraindication, financial challenges, a lack of availability of the techniques, or a fear of the patient, to name but a few.

This means that most ametropic persons rely on visual aids, which can be an obstacle in many everyday situations, for example, to be able to look briefly at mobile phones in order to know the time of day, when walking in a pedestrian zone, at night where it may be necessary to put on or remove glasses, or to have to change from far vision to short vision in a different way.

Moreover, when driving in a car, a gaze of a driver whose accommodation capability is limited can entail considerable risks, in particular when a visual aid is set for far vision or near vision on a display such as, for example, a speed display or a navigation system on a dashboard, a center console, or a head-up display (HUD). In addition, the use of the complex multidimensional special display devices addressed represents a considerable cost factor, and the availability cannot be guaranteed for most persons.

### SUMMARY

It is therefore an object of the invention to provide an easily available and cost-effective method that enables a display to be controlled in such a way that it can be read more easily by an ametropic person.

The object of the invention is achieved by the method according to the invention, the device according to the invention, the computer program according to the invention, and the computer-readable medium according to the invention. Advantageous embodiments with expedient developments of the invention are specified in the examples provided herein, wherein advantageous embodiments of the method are to be regarded as advantageous embodiments of the display apparatus, the computer program, and the computer-readable medium, and vice versa.

In a first embodiment, the invention provides a method for compensating a user's (a patient's) defective vision for a display apparatus of the display apparatus, the method comprising the steps of: Firstly, defective vision parameters of the user are determined using an input device. This may comprise a manual input of the data by the user, or may comprise a query of a database or an external device. For example, ophthalmological diagnostic data (e.g., topography data) of the user may also be used as input data for compensating the defective vision.

Furthermore, a calculation of compensation data is performed by a compensation data calculating device for adapting predetermined image data based on the defective vision parameters. The defective vision parameters may comprise, for example, a spherical correction value for each eye of the user, an astigmatism value, an axial position of the astigmatism, and further data. The predetermined image data are further image data that are to be displayed on a display device of the display apparatus. Herein, the image data that are to be displayed on the display device may be two-dimensional image data or image stream data (video data) or may be data of a three-dimensional model that is to be rendered and displayed, for example, by the control device.

Furthermore, an adaptation or changing or conversion of the predetermined image data dependent on the compensation data is performed by the control device.

Subsequently, an adaptation or changing or conversion of the predetermined image data dependent on the compensation data is performed by the control device. In this respect, spatial and/or intensity-related information can be adapted. This may result, for example, for persons with highly defective vision, in a difference between a situation in which the person does not recognize anything at all and a situation in which the person can recognize and correctly interpret outlines of a time or a speed information.

The conversion of the predetermined image data may be performed, for example, using a predetermined algorithm. Furthermore, the conversion may be performed on a control device or for example on a terminal on which the image data is processed.

Finally, the display device is driven by the control device with the adapted image data. This control device may receive, for example, as a control device of a mobile terminal, the defective vision parameters as well as the predetermined image data as input, and may adapt or convert, using the algorithm, these predetermined image data into adapted image data (picture element information) that can be output by a display device of the mobile terminal.

It should be noted that, using the invention, a conventional display device may be used that does not have to be a multilayer or overlay display device, but that may be a simple “single-layer” display device.

The control device is thus able to process the predetermined image data, i.e. brightness information, color information, an arrangement of the predetermined image data and/or a time-dependent sequence of the predetermined image data in such a way that the display device can display the adapted image data. A user of the method can thus more easily recognize the predetermined image data. The adaptation of the predetermined image data comprises at least a processing of the intensity data, i.e. a processing of color, brightness or arrangement information, and comprises an adaptation of the information in such a way that the user with the above-mentioned defective vision can recognize the displayed image more sharply or as nearly sharp, or can recognize it at all, without using a further visual aid.

In one example, a user specifies his own defective vision information as an input parameter. If, for example, the user wears a visual aid for far vision, but also wishes to be able to read a display device with this visual aid, which may be located at a short distance, the display on the display device can be adapted using the method in such a way that the user can also read the display device when wearing the visual aid. Optionally, the user can input such input parameters that they are adapted to a situation in which he does not wear a visual aid at the moment of viewing.

It may occur that information is lost during the adaptation of the predetermined image data, a display resolution is reduced, or an effective image size also has to be adapted via a scaling, but the benefit for highly ametropic persons is nevertheless outstanding. The invention results primarily in the advantage that a method is provided that enables ametropic persons to be able to read a display easily, and that is easily available, since a conventional display device may be used that does not have to be a multilayer or overlay display device, but may be a simple “single-layer” display device.

The invention also comprises further embodiments that result in additional advantages.

An advantageous embodiment provides that the adaptation of the predetermined image data by the compensation data comprises a phase adaptation and/or an intensity adaptation of respective pixels. This means that an adaptation of the predetermined image data by a compensation of a phase information and/or by an adaptation of an intensity information of pixels is also comprised. This embodiment also results in the advantage that an ametropic person can easily read a display that would otherwise not be readable or would be readable only with difficulty.

A further advantageous embodiment provides that the adaptation of the predetermined image data by the compensation data is based on an inverse function of an optical transfer function. This means that an optical transfer function can be modeled on the basis of the defective vision parameters, and an inverse function to this optical transfer function can be calculated on the basis of the optical transfer function. Subsequently, the predetermined image data can be adapted in that this inverse function is applied to the predetermined image data in order to obtain the adapted image data. This embodiment thus provides a simple implementation option of the method according to the invention.

A further advantageous embodiment provides that the adaptation of the predetermined image data by the compensation data comprises a generation of a hybrid image. In this respect, a hybrid image can be a superposition of two individual images, wherein a first individual image is filtered using a spatial low-pass filter in order to remove high-frequency image element components, and a second individual image is high-pass filtered in order to filter out low-frequency components of the image, wherein subsequently both filtered images are added to one another in a calculated manner, for example added in a weighted manner, multiplied or entirely or partially superimposed. In this respect, a hybrid image can be configured in such a way that, in the case of a strong magnification of the image, the high-frequency components of the second individual image are more visible than the low-pass filtered components of the first individual image, whereas, in the case of a strong reduction of the image, the low-pass filtered components of the first individual image are more visible than the high-pass filtered components of the second individual image. Thus, a generation of a hybrid image represents a simple implementation of the method according to the invention. In this sense, in the invention, different information can be integrated in the hybrid image, for example integrated spatially (for example top-bottom or right-left) or also temporally (one image after the other).

In a further advantageous embodiment it is provided that the adaptation of the predetermined image data by the compensation data comprises a compensation of a phase relationship, in particular of an emission time, for respective image data. This means that an adaptation of the predetermined image data can be performed by a compensation of an emission time. This corresponds to an adaptation of a phase relationship of the predetermined image data. Thus, there is a further improvement in the inclusion of phase information of the image, which is missing in a mere viewing of the preconditioned image data. It is thus conceivable to supplement the image element intensity information with time-dependent information. As a result, an effective image repetition rate can be reduced, and a computing effort can be increased, but this does not represent a real disadvantage in the case of present-day display devices and present-day image repetition rates or in the case of the present-day computing powers of mobile terminals.

In a further advantageous embodiment it is provided that the method is performed on a mobile terminal, in particular on a smartphone. Thus, the method can be made available to a wide range of users, either via a possibility of downloading an application that implements the method in an app store, downloading via a web page, or making a program or an application available on a terminal at a time of manufacture of the terminal.

In a further advantageous embodiment it is provided that a time-dependent controlling of the pixels of the display apparatus is modified by the compensation data. This means that each pixel can be individually controlled in a time-dependent manner in order to achieve a desired display effect that makes it easier for the user of the display device to capture and understand the image information.

In a further advantageous embodiment it is provided that the adaptation of the predetermined image data by the compensation data further comprises that a database-based combination of diagnostic data and compensation data is used to provide improved compensation data. This means that an improved allocation between diagnostic data and compensation data is possible using a recording of diagnostic data and associated compensation data, and in particular by a statistical evaluation of this data. In addition, an additional user-based weighting can be added that evaluates a visual impression of the respective user and thus prefers compensation data that is better suited for the compensation.

This embodiment may comprise, for example, that after the input of the defective vision data of the user, the control device queries a database in order to determine recorded, in particular suitable combinations of diagnostic data and compensation data. Furthermore, this embodiment may comprise that after the calculation of the compensation data and an optional evaluation of the compensation by the user, the control device transmits data, in particular the diagnostic data, the compensation data, and evaluation data to the database. This embodiment has the advantage that particularly suitable pairings of diagnostic data and compensation data are available to be retrieved in the database for use in the control device.

Furthermore, the embodiment may comprise that machine learning methods (machine learning) are used to identify compensation data that are particularly suitable for predetermined diagnostic data. This means that the control device may be directed to direct a query to a server that executes trained artificial intelligence software to answer such queries, wherein the query may comprise the diagnostic data and optionally further data. In this respect, using trained data, the server may be configured to identify corresponding diagnostic data and to return them to the control device in a response.

For this purpose, it is provided in particular to train a predetermined instance of artificial intelligence (which is executed as software on the server) with pairings of diagnostic data and compensation data, to which an evaluation or weighting parameter is additionally attached that indicates a suitability for compensating a defective vision. In this respect, it may be provided to provide, for the learning process, data of pairings and weighting parameters that comprise a wide spectrum of defective visions such as, for example, a defective vision (myopia, hyperopia) of, for example, −12 D to +12 D in steps of 0.25 D, an astigmatism with different axial positions (for example, all) 5° and different intensities (of −10 D to 10 D in steps of 0.25 D), or comprise higher-order aberrations such as clover leaf aberrations, coma, and spherical aberrations to the normal extent. For this different defective vision data, it may be provided to provide well-suited compensation data and unsuited compensation data, in each case with corresponding weighting parameters, for the learning process.

Furthermore, the respective method may comprise at least one additional step that is executed precisely when an application case or an application situation occurs that has not been explicitly described here. The step may comprise, for example, the output of an error message and/or the output of a prompt for inputting a user feedback. Additionally or alternatively, it may be provided that a standard setting and/or a predetermined initial state is set.

A further embodiment of the invention relates to a display apparatus for compensating a user's defective vision with a control device, a display device, a compensation data calculating device, and/or an input device, wherein the display apparatus is configured to perform one of the preceding methods.

In addition, the control device may comprise a computing unit for electronic data processing, such as, for example, a processor. The computing unit may comprise at least one microcontroller and/or at least one microprocessor. The computing unit may be configured as an integrated circuit and/or microchip. Furthermore, the control device may comprise a (electronic) data memory or a memory unit. Program code may be stored on the data memory, by which the steps of the respective embodiment of the respective method are encoded. The program code may comprise the control data for the respective laser. The program code may be executed using the computing unit, whereby the control device is caused to execute the respective embodiment. The control device may be configured as a control chip or control device. The control device may be comprised, for example, by a computer or computer network.

A further embodiment of the invention relates to a computer program. The computer program comprises instructions that form, for example, a program code. The program code may comprise at least one control data record with the respective control data for the respective laser. When executing the program code using a computer or a computer network, the computer or computer network is caused to execute the previously described method or at least one embodiment thereof.

A further embodiment of the invention relates to a computer-readable medium (storage medium) on which the aforementioned computer program or the instructions thereof are stored. To execute the computer program, a computer or a computer network may access the computer-readable medium and read out the contents thereof. The storage medium is configured, for example, as a data memory, in particular at least partially as a volatile or non-volatile data memory. A non-volatile data memory may be a flash memory and/or an SSD (solid state drive) and/or a hard disk. A volatile data memory may be a RAM (random access memory). The instructions may be present, for example, as source code of a programming language and/or as assembler and/or as binary code.

Further features and advantages of one of the described embodiments of the invention may result from the embodiments of another of the embodiments of the invention. The features of the embodiments of the invention may thus be present in any combination with one another, unless they have been explicitly described as mutually exclusive.

### BRIEF DESCRIPTION OF THE DRAWINGS

Additional features and advantages of the invention are described below with reference to the figures in the form of advantageous embodiments. The features or feature combinations of the embodiments described below may be present in any combination with one another and/or the features of the embodiments. That is, the features of the embodiments may supplement and/or replace the features of the embodiments, and vice versa. Thus, embodiments of the invention are also to be regarded as comprised and disclosed that are not explicitly shown or explained in the figures, but result from and can be generated by separate feature combinations from the embodiments and/or embodiments. Thus, embodiments are also to be regarded as disclosed that do not have all the features of an originally formulated claim or that go beyond or differ from the feature combinations set out in the back references of the claims.

With regard to the embodiments:

FIG. 1 shows a display apparatus for compensating a human user's defective vision; and

FIG. 2 shows a flow diagram of a method for compensating a user's defective vision of the display apparatus.

### DETAILED DESCRIPTION

In the figures, identical or functionally identical elements are provided with the same reference symbols.

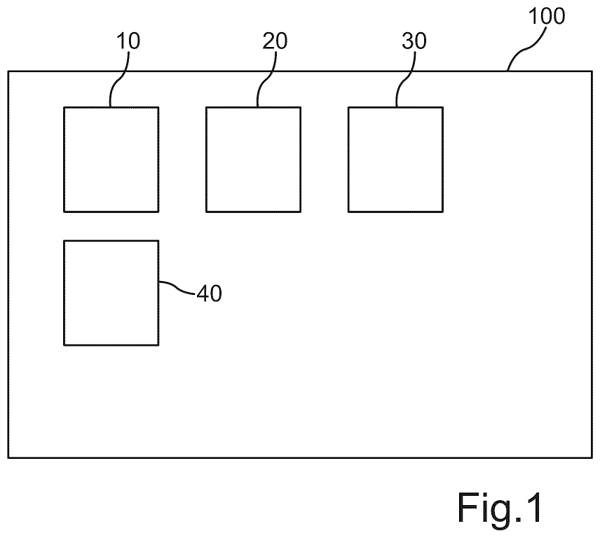

With regard to the embodiments, FIG. 1 shows a display apparatus 100 for compensating a human user's defective vision with a display device 10, a compensation data calculating device 20, an input device 30 and a control device 40.

Using the input device 30, the user can input defective vision parameters, or the defective vision parameters of the user can be determined. In addition, this can be performed, for example, using a database query, or can be performed, for example, using an interface to an external device such as, for example, a diagnostic device. Furthermore, ophthalmological diagnostic data (e.g., topography data) of the user may be used as input data for compensating the defective vision.

Using the compensation data calculating device 20, compensation data for adapting predetermined image data based on the defective vision parameters can be calculated. This means that compensation data is calculated using the compensation data calculating device 20, and this compensation data can subsequently be used in order to adapt or convert the predetermined image data in such a way as to obtain or determine adapted image data. This means that, for example, using the control device 40, the predetermined image data can be adapted or changed or converted dependent on the compensation data. The control device 40 may be comprised in the display apparatus 100, or may be provided as an external device to the display apparatus 100. In a further embodiment, the control device may be configured to forward calculated compensation data to a database for collection and, for example, statistical evaluation.

Subsequently, the display device 10 can be driven in order to display the adapted image data. Using the invention, a conventional display device may be used in this respect that does not have to be a multilayer or overlay display device, but that may be a simple “single-layer” display device.

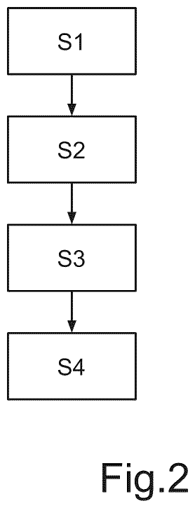

FIG. 2 shows a method for compensating a user's defective vision for a display apparatus 100. The method may comprise the following steps.

In a first step S1, the defective vision parameters of the user are determined using an input device (30) or by an input device (30). In this respect, for example, the defective vision parameters of the user of the device can be input. Furthermore, a determination of defective vision parameters can also be performed by a database query or via an interface. Furthermore, ophthalmological diagnostic data (e.g., topography data) of the user may be used as input data for compensating the defective vision. In addition, this step can be skipped if the defective vision parameters are already known and/or the compensation data is already stored in the control device.

In a step S2, compensation data is calculated based on the defective vision parameters, which compensation data can be used for an adaptation of predetermined image data. The predetermined image data is in turn image data that is to be displayed on the display apparatus 100. Furthermore, this step can be skipped if the compensation data has already been calculated in the control device and/or are already stored.

In a step S3, an adaptation or changing or conversion of the predetermined image data dependent on the compensation data is performed. This step can be repeated as often as required, wherein the predetermined image data is in each case provided again and is adapted based on the defective vision parameters in order to obtain new adapted image data.

In a step S4, a display device (10) of the display apparatus 100 is driven by the control device 40 with the adapted image data. In this respect, the adaptation of the predetermined image data by the compensation data may comprise a phase adaptation and/or an intensity adaptation of respective pixels. After the driving of the display device, the method can return to step S3 in order to apply the compensation data to further predetermined image data.

Furthermore, the adaptation of the predetermined image data by the compensation data may be based on an inverse function to an optical transfer function. In addition, the adaptation of the predetermined image data by the compensation data may comprise a generation of a hybrid image. In addition, the adaptation of the predetermined image data using compensation data may comprise an adaptation of a phase relationship, in particular of an emission time, for respective image data. In addition, a time-dependent controlling of the pixels of the display device 10 can be modified by the compensation data. It should be noted that the method can be performed on a mobile terminal such as, for example, a smartphone.

Overall, the embodiments show how a method for providing control data for a display apparatus, a control device, a display apparatus, a computer program, and a computer-readable medium can be provided.

### REFERENCE NUMERAL LIST

10 display device
20 compensation data calculating device
30 input device
40 control device
100 display apparatus

1. A method for compensating a user's defective vision for a display apparatus, the method comprising the steps of:
determining defective vision parameters of the user using an input device;
calculating compensation data by a compensation data calculating device for adapting predetermined image data based on the defective vision parameters;
adapting the predetermined image data dependent on the compensation data by a control device; and
driving a display device of the display apparatus by the control device with the adapted image data.

2. The method according to claim 1, wherein the adaptation of the predetermined image data by the compensation data comprises a phase adaptation and/or an intensity adaptation of respective pixels of the display device.

3. The method according to claim 1, wherein the adaptation of the predetermined image data by the compensation data is based on an inverse function of an optical transfer function.

4. The method according to claim 1, wherein the adaptation of the predetermined image data by the compensation data comprises a generation of a hybrid image.

5. The method according to claim 1, wherein the adaptation of the predetermined image data by the compensation data comprises an adaptation of a phase relationship, in particular of an emission time, for respective image data.

6. The method according to claim 1, wherein the method is performed on a mobile terminal, in particular on a smartphone.

7. The method according to claim 1, wherein a time-dependent controlling of pixels of the display device is modified by the compensation data.

8. The method according to claim 1, wherein the adaptation of the predetermined image data by the compensation data further comprises that a database-based combination of diagnostic data and compensation data is used to provide improved compensation data.

9. A display apparatus for compensating a user's defective vision with a control device, a display device, a compensation data calculating device, and/or an input device, wherein the display apparatus is configured to perform the method according to claim 1.

10. (canceled)

11. A computer-readable medium for storing a computer program, the computer program comprising instructions that cause a display apparatus to perform the method according to claim 1.
